(19) United States
(12) Patent Application Publication
(10) Pub. No.: US 2008/0264641 A1
(43) Pub. Date: Oct. 30, 2008

(54) Blending Fracturing Gel

(76) Inventors: Billy F. Slabaugh, Duncan, OK (US); Max L. Phillippi, Duncan, OK (US); Calvin L. Stegemoeller, Duncan, OK (US)

Correspondence Address: JOHN W. WUSTENBERG, P.O. BOX 1431, DUNCAN, OK, 73536, US

(21) Appl. No.: 11/742,437

(22) Filed: Apr. 30, 2007

(51) Int. Cl. E21B 43/26; B01F 15/02; B01F 15/04

(52) U.S. Cl. 166/308.2; 366/162.1; 366/165.3

(57) ABSTRACT

The present disclosure relates to a system and method for producing a well-fracturing gel using a gel concentrate such that the method and system are capable of timely adjusting the properties of the gel on the fly just prior to introducing the gel into the well. Further, the present disclosure provides for producing a gel with an overall shorter production time as well as adjusting the properties of the gel just prior to injecting the gel into the well.

### TECHNICAL FIELD

This disclosure relates to fracturing a subterranean zone.

### BACKGROUND

Gels for well fracturing operations have traditionally been produced using a process wherein a dry gel and a liquid, such as water, are combined in a single operation. However, the gel mixture requires considerable time to hydrate prior to being introduced down a well. Moreover, the gel continues to be produced while the gel hydrates, creating a working volume of gel that is used in a first in first out manner for the fracturing operation. Thereafter, as the gel is introduced into the well, a change to the gel may be required in order to address the specific needs of the fracturing operation. For example, the gel may require an additive to reduce the reactivity of the gel to the well formation or the viscosity of the gel may require modification in order to properly fracture the well. However, the working volume must be used up before the gel having the modified properties is available to be introduced into the well. As such, there is a significant lag between a change to the composition of the gel and the introduction of the modified gel into the well. This delay can be significant—up to one quarter of the total time to perform a fracturing operation.

### SUMMARY

The present disclosure relates to a system and method for producing gel in a reduced time period using a gel concentrate such that the method and system are capable of timely adjusting the properties of the gel on the fly just prior to introducing the gel into the well. Accordingly, the present disclosure provides for producing a gel with an overall shorter production time as well as adjusting the properties of the gel just prior to injecting the gel into the well, thereby significantly reducing or eliminating any lag period between a change in the gel and injection of the gel into the well.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a schematic view of a dry gel production system for producing a fracture stimulation gel using a gel concentrate;

FIG. 2 is a mobile gel-production apparatus capable of producing a gel concentrate according to one implementation;

FIG. 3 is a detail view of dry handling system for transporting and delivering a dry gel for the production of a gel or a gel concentrate according to one implementation;

FIG. 4 is another view of the dry handling system of FIG. 3;

FIG. 5 is a schematic view of an apparatus for mixing and hydrating a dry gel according to one implementation;

FIG. 6 shows a conveyor system and cyclone separator of the dry handling system of FIG. 3;

FIG. 7 shows a perspective view of a gel mixing system according to one implementation;

FIG. 8 is another view of the gel mixing system of FIG. 7;

FIG. 9 is a detail view of a hydration tank according to one implementation;

FIG. 10 is a control system for controlling various functions of a polymer gel production system, according to one implementation;

FIG. 11 is an output system for controlling an output of a polymer gel concentrate according to one implementation; and

FIG. 12 is a schematic view of a dry gel production system for producing a fracture stimulation gel directly from a dry gel and a liquid.

### DETAILED DESCRIPTION

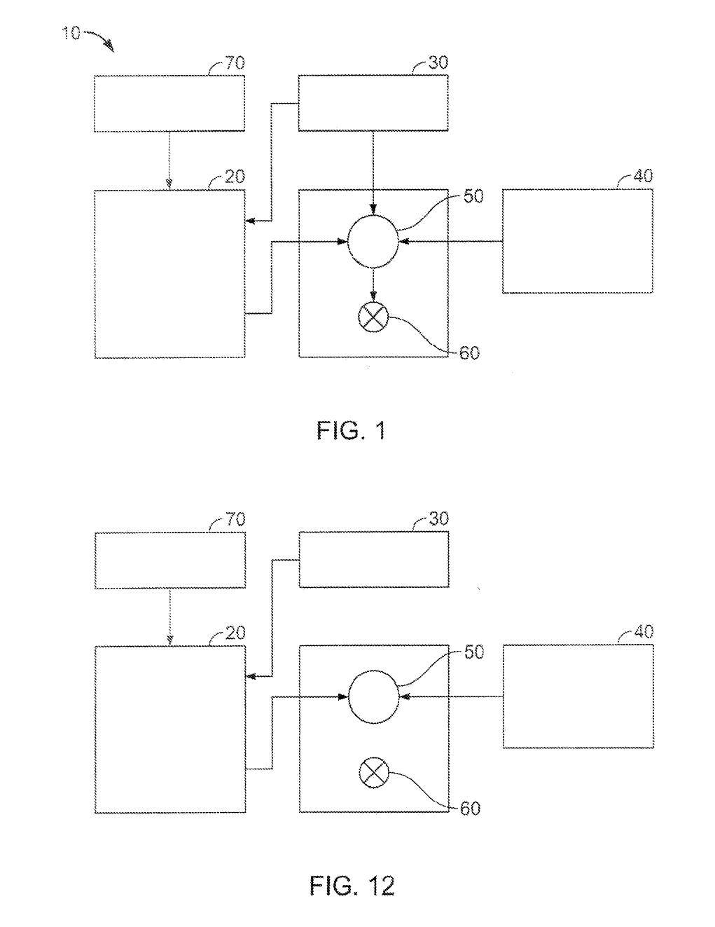

FIG. 1 is one example of a system 10 adapted to hydrate a dry gel for use in fracture stimulating a subterranean zone. The system 10 includes a hydrated gel producing apparatus 20, a liquid source 30, a proppant source 40, and a blender apparatus 50 and resides at a surface well site. The hydrated gel producing apparatus 20 combines dry gel with liquid, for example from liquid source 30, to produce a hydrated gel. In certain implementations, the hydrated gel can be a gel for ready use in fracture stimulation or a gel concentrate to which additional liquid is added prior to use in fracture stimulation. Although referred to as “hydrated,” the hydrating fluid need not be water. For example, the hydrating fluid can include a water solution (containing water and one or more other elements or compounds) or another liquid. In some of the embodiments described herein, the blender apparatus 50 receives the gel for ready use in fracture stimulation and combines it with other components, often including proppant from the proppant source 40. In other instances, the blender apparatus 50 receives the gel concentrate and combines it with additional hydration fluid, for example from liquid source 30, and other components often including proppant from the proppant source 40. In either instance, the mixture may be injected down the wellbore under pressure to fracture stimulate a subterranean zone, for example to enhance production of resources from the zone. The system may also include various other additives 70 to alter the properties of the mixture. For example, the other additives 70 can be selected to reduce or eliminate the mixture's reaction to the geological formation in which the well is formed and/or serve other functions. Although the additives 70 are illustrated as provided from a separate source, the additives 70 may be integrally associated with the apparatus 20.

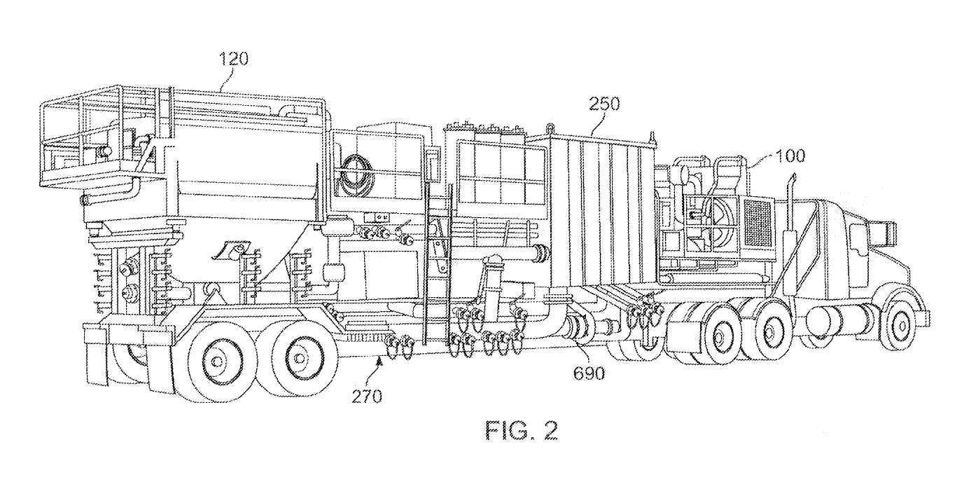

FIG. 2 illustrates an implementation of the apparatus 20 for producing the gel concentrate. The apparatus 20 of FIG. 2 may also generate a gel directly. As shown, the apparatus 20 is portable, such as by being included on or constructed as a trailer transportable by a truck. The apparatus 20 may include a bulk material tank 80, a hydration tank 90, a power source 100, and a control station 110. Other features may also be included.

According to one implementation, the power source 100 may be a diesel engine, such as a Caterpillar® C-13 diesel engine, including a clutch. However, the present description is not so limited, and any engine or other power source capable of providing power to the apparatus 20 may be utilized. The power source may also include hydraulic pumps, a radiator assembly, hydraulic coolers, hydraulic reservoir (e.g., a 70-gallon hydraulic reservoir), battery, clutch, gearbox (e.g., a multi-pad gearbox with an increaser), maintenance access platforms, battery box, and one or more storage compartments. Although not specifically illustrated, these features would be readily understood by those skilled in the art. The power source 100 provides, entirely or in part, power for the operation of the apparatus 20. The control station 110 provides for control of the various functions performed by the apparatus 20 and may be operable by a person, configured for automated control, or both. The control station 110 may, for example, control an amount of dry gel and liquid combined in a gel mixer (discussed below), the rate at which the gel mixer operates, an amount of gel concentrate maintained in a hydration tank (discussed below), and a gel concentrate output rate. The control station 110 may also control an amount of dry gel dispensed from a bulk-metering tank (discussed below) as well as monitor an amount of dry gel remaining in the bulk-metering tank. Further, the control station 110 may be operable to monitor or control any aspect of the apparatus 10. The apparatus 20 may also include various pumps, such as liquid additive pumps, suction pumps, and concentrate pumps; mixers; control valves; flow meters, such as magnetic flow meters; conveying devices, such as conveying augers, vibrators, pneumatic conveying devices; and inventory and calibration load cells.

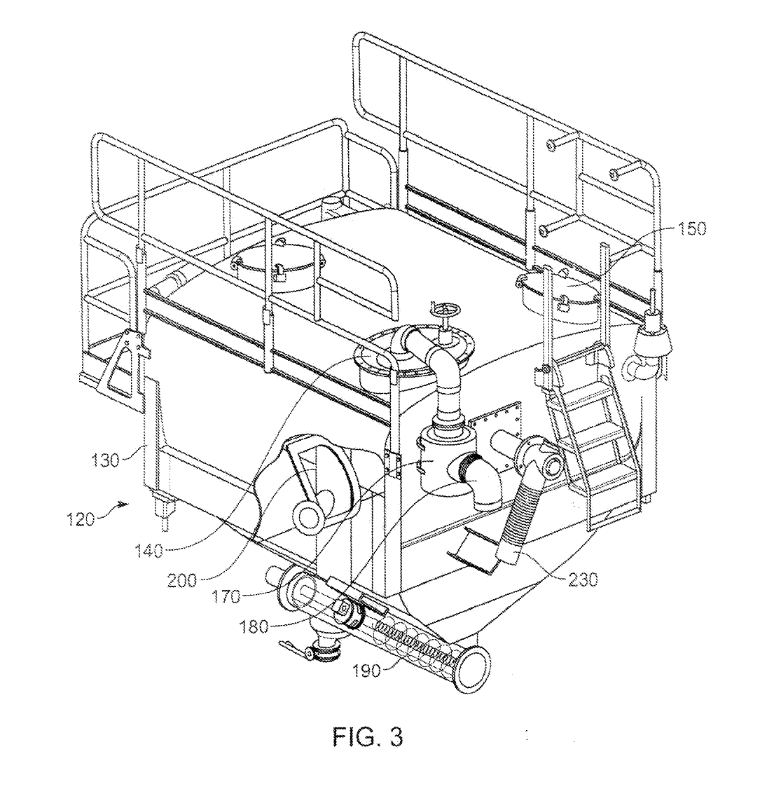

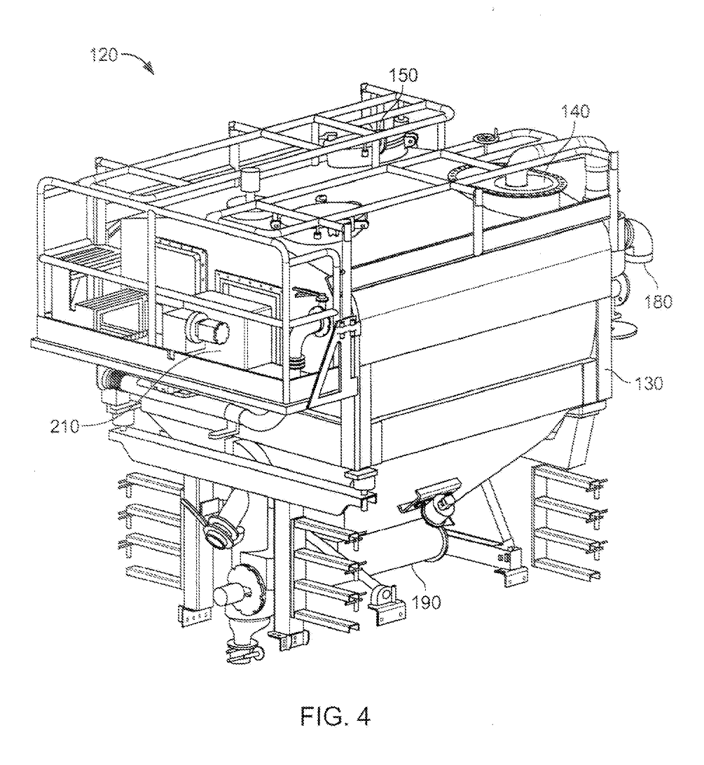

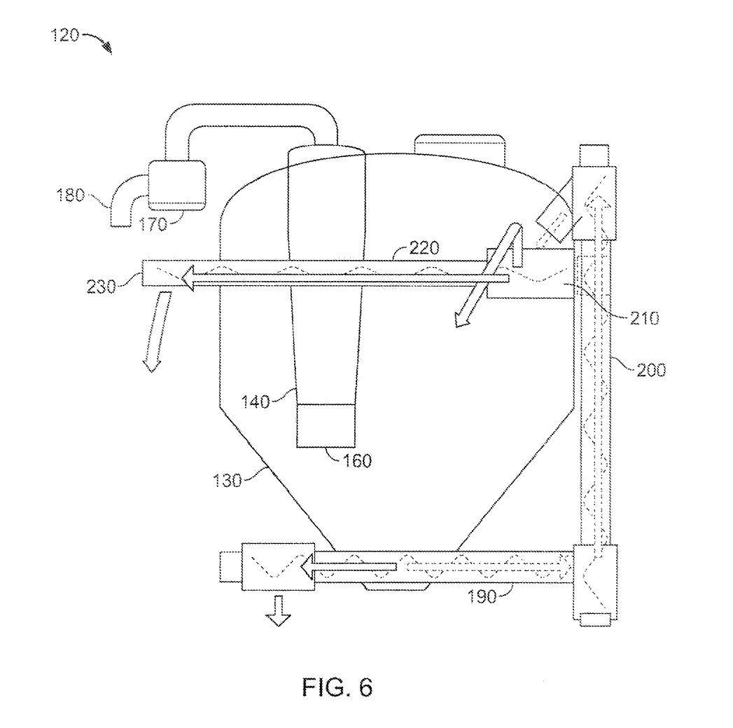

A dry gel handing system is now described with reference to FIGS. 3-6. FIG. 6 shows a schematic diagram of material flow through the dry handling system 120. The dry gel handling system (interchangeably referred to as “handling system”) 120 includes a bulk tank 130 having a cyclone separator 140 and fill hatch 150 used to fill the bulk tank 130 with dry gel. The dry gel is a bulk powder material including, for example, hydratable polymers such as cellulose, karaya, xanthan, tragacanth, gum ghatti, carrageenin, psyllium, gum acacia, carboxyalkylguar, carboxyalkylhydroxyalkylguar, carboxyalkylcellulose, carboxyalkylhydroxyalkylcelluose, and the like wherein the alkyl radicals include methyl, ethyl, or propyl radicals. Dry gel materials may also include, for example, hydratable synthetic polymers and copolymers such as polyacrylate, polymethacrylate, acrylamide-acrylate copolymers, and maleic anhydride methylvinyl ether copolymers. Other dry gel polymers include cmhpg, hpg, guar, hec, cmhec. When filling the bulk tank 130, an amount of dry gel dust it created. Dusting is worsened as the air, being displaced by the incoming dry gel, is forced out of the tank 130. Consequently, the cyclone separator 140 residing within the bulk tank 130 is utilized to capture and separate the dry gel dust created during filling and/or operation of the handling system 120. Once separated from the air, the dry gel dust falls into a lower portion of the cyclone separator 140 where it is released back into the tank 130. According to one implementation, the dry dust falls into a collecting chamber 160 at the bottom of the cyclone separator 140. The collecting chamber 160 is then emptied at specified intervals back into the bulk tank 130. According to one implementation, a bulk tank 130 having an 8,000 lb. capacity may be filled within one to three minutes. Air captured by the cyclone separator 140 is then transported to a filter 170 where additional dry gel still entrained in the air may be removed, and the air is then exhausted to the environment through an exhaust pipe 180.

The handling system 120 also includes a series of conveyors to transport the bulk dry gel to a gel mixer where the dry gel is subsequently mixed with a liquid. A first horizontal conveyor 190 is located at a lower portion of the bulk tank 130. The first conveyor 190 may be an auger that conducts an amount of the dry gel to a vertical conveyor 200 that may also be an auger. The vertical conveyor 200 conducts the dry gel upwards where the dry gel is released into a hopper 210. A second horizontal conveyor 220 carries the dry gel to the gel mixer 290. According to one implementation, the first horizontal and vertical conveyors 190, 200 operate at a constant speed. Thus, the conveyors 190, 200 have constant dry gel conveying rates. The second horizontal conveyor 210 may be operable at variable speeds according to the concentration and volume of gel required. In one implementation the conveyor 210 may be an Acrison® feeder manufactured by Acrison, Inc., 20 Empire Blvd., Moonachie, N.J. 07074. According to a further implementation, the conveying rate of the conveyors 190, 200 may be set so that an amount of dry gel delivered to the hopper 210 will always exceed the amount of dry gel conveyed by the second horizontal conveyor 220. Consequently, dry gel delivered to the hopper 210 will always exceed an amount of dry gel drawn therefrom so that the quantity of dry gel delivered by the second horizontal conveyor 220 remains uniform. The excess dry gel delivered to the hopper 210 overflows and is returned back to the bulk tank 130. The dry gel exits the handling system 120 through an outlet 230.

The handling system 120 is capable of accurately delivering a desired amount of dry gel via the second horizontal conveyor 220. Because the hoper 210 is maintained in a full condition by the conveyors 190 and 200, the system 10 is able to accurately measure an amount of dry gel fed by the conveyor 220 based on the conveyor 220's operating speed. However, the handling system 120 may also include a back up or alternate mechanism for ensuring accurate and consistent delivery of dry gel to the gel mixer. Accordingly, the bulk tank 130 may include load sensors (“load cells”) 240 provided at, for example, the corners of the bulk tank 130. The outputs of the load cells 240 provide an indication of the amount of bulk material, by weight (or mass), contained in the bulk tank. Therefore, the load cells 240 provide not only an indication of an amount of dry gel remaining in the bulk tank 130 but also an indication of the rate the dry gel being fed therefrom based on the rate of change in the weight, as measured by the load cells 240. Further, an operator of the system 10 (shown in FIG. 1), such as a human operator or computer system, may determine a problem exists if the load cells indicate that, although sufficient dry gel in present in the bulk tank 130 based on the loads detected, the weight of the bulk tank 130 is not changing despite the fact that the conveyors 190, 200, and 220 are operating. Thus, although the conveyor 220 is operating and, therefore, indicating delivery of a specified amount of dry gel, the unchanging loads measured by the load cells 240 indicate that no dry gel is being output from the bulk tank 130 and that a problem exists, requiring corrective action. Further, the rate of weight decrease measured by the load cells 230 may be compared to the specified output of the conveyor 220 to determine if the conveyor 220 is properly calibrated.

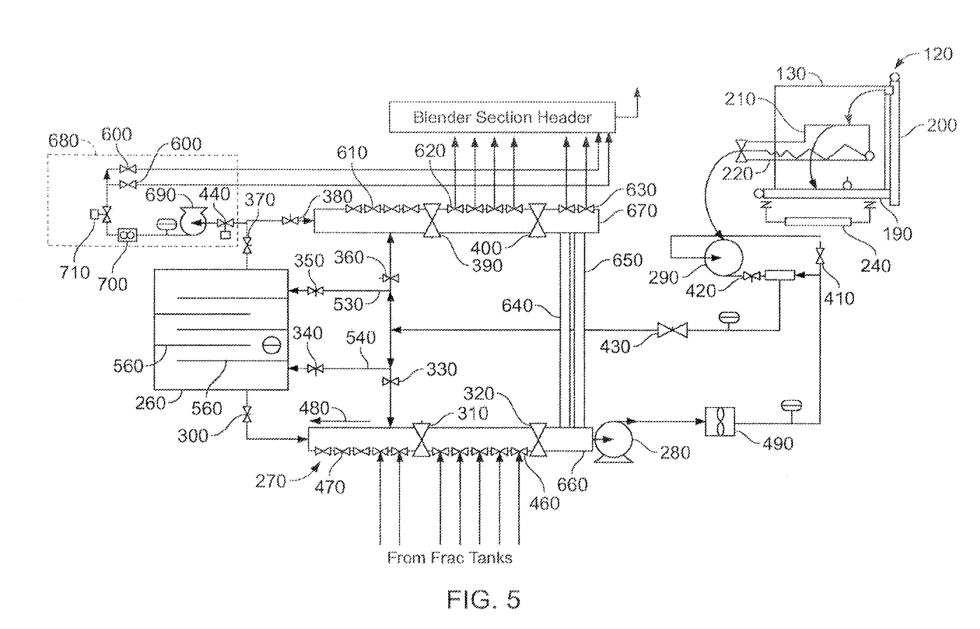

FIGS. 5 and 7-8 illustrate a gel concentrate mixing system (“mixing system”) 250 of the apparatus 20 according to one implementation. The mixing system 250 includes a hydration tank 260, a piping system 270, a suction pump 280, and the gel mixer 290. According to the implementation shown in FIG. 5, the piping system 270 includes a plurality of valves (valves 300-440) to direct the flow of materials through the mixing system 250 according to the needs or desires of an operator. However, the mixing system 250 may include a different quantity of valves and may include a different piping layout than the one illustrated in FIGS. 5 and 7-8 while still being within the scope of the present disclosure. According to another implementation, the mixing system 250 is capable of producing both a gel concentrate as well a finished gel.

A liquid, such as water, is introduced into the mixing system 250 via one or more fittings 460. The liquid may be provided from the liquid source 30 (shown in FIG. 1). Optionally, gel liquid may also be introduced through one or more fittings 470. If only fittings 460 are used, the valve 310 is closed to prevent the gel liquid from flowing towards the hydration tank 260, as indicated by arrow 480. If gel liquid is introduced from one or more of the fittings 460 and 470, valves 300 and 330 are closed and valve 310 is opened. The valve 320 is also opened so that the liquid may be pumped via the suction pump 280 to the gel mixer 290. According to one implementation, the suction pump is a 10×8 Gorman-Rupp pump manufactured by the Gorman-Rupp Company, P.O. Box 1217, Mansfield, Ohio 44901, however, it is within the scope of the disclosure that other pumps may be used. The suction pump 280 and the gel mixer 290 may be powered by the power source 100.

The liquid flows through a flowmeter 490, such as a magnetic flowmeter, to determine the flowrate of the liquid introduced into the mixing system 240 and is then conveyed to the gel mixer 290. Valve 420 may be opened to introduce liquid into the gel mixer 290 at a first location 500 of the gel mixer 290. Similarly, the valve 410 may also be opened to introduce liquid into a second location 510 of the gel mixer 290. Valves 410 and 420 may be manipulated so that liquid is introduced in only one of the first or second locations 500, 510 or both valves 410 and 420 may be opened to permit the liquid to be introduced at both the first and second locations 500 and 510. Dry gel exiting from the outlet 230 of the handling system 120 enters the gel mixer 290 through an opening 520. There the dry gel is mixed with the liquid to form a gel concentrate. Although the system 10 is capable of producing both a completed gel and gel concentrate, production of a gel concentrate, as opposed to a completed gel, provides significant advantages. For example, as described below, producing a gel concentrate can enable significantly improving the reaction time between changing the properties of the gel produced and the time delay after which a modified gel is introduced into the well. Other advantages are described below.

The gel mixer 290 agitates and blends the dry gel and liquid. In one implementation the agitating and blending is preformed using an impeller as the two components are combined. Consequently, the blending causes a faster, more thorough mixing as well as increases the surface area of the dry gel particles so that the particles are wetted more quickly. Thus, the gel concentrate production time is decreased. Further, this type of gel mixer 290 is capable of mixing the dry gel and liquid at any rate or ratio. Thus, when producing a gel concentrate, as opposed to a finished gel, a reduced amount of liquid is used and, hence, the gel concentrate is produced more quickly. According to one implementation, the gel mixer 290 is of a type described in U.S. Pat. No. 7,048,432, the entirety of which is incorporated herein by reference.

Conversely, eductors presently utilized to form a fracturing gel are specifically sized for mixing materials at a single, specified ratio. Thus, in order to change the mixing ratio, one eductor had to be removed and a new eductor installed, requiring substantial delay and large manpower requirements to effect the mixing ratio change. Accordingly, presently available eductors are not operable to change a mix ratio of a gel on the fly. Consequently, the present disclosure provides a system for improved flexibility and responsiveness to the requirements of a given well.

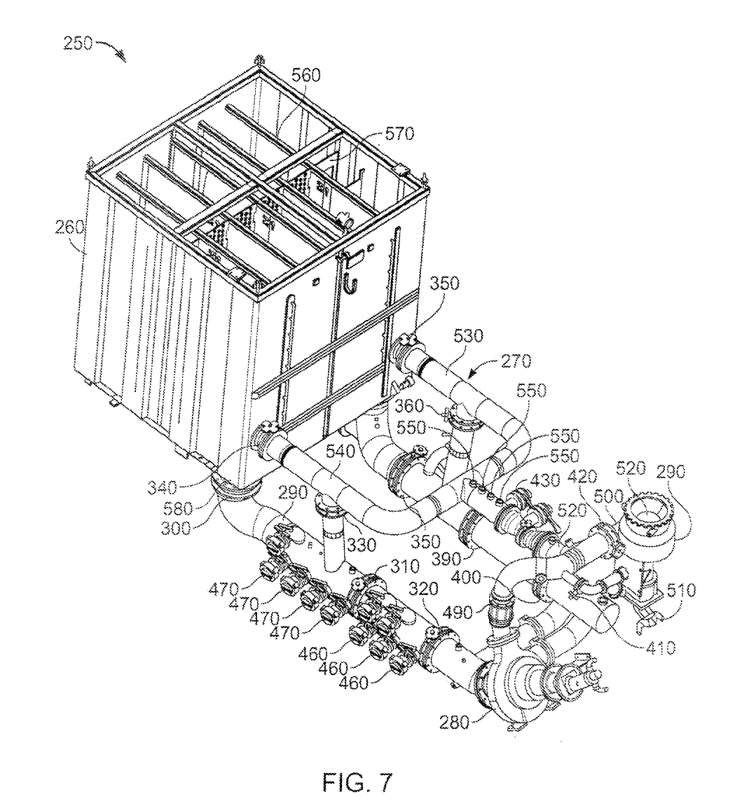

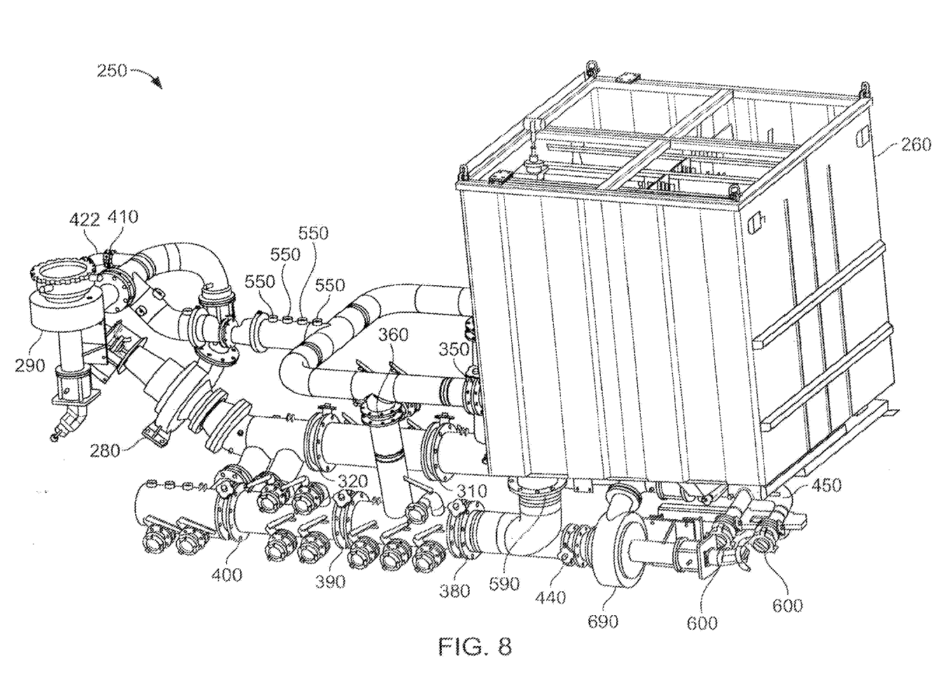

As shown in FIGS. 7 and 8, the first location liquid inlet 500 and the gel concentrate outlet are concentric, wherein the gel concentrate exits at 520 while the liquid enters at 500 through an annulus formed between an outer pipe and an inner pipe transporting the gel concentrate. However, other implementations may use a gel outlet that is separate from the liquid inlets of the gel mixer 290.

The gel concentrate is then directed through a metering valve 430 to control an amount of gel concentrate exiting the gel mixer and, hence, an amount of gel concentrate produced by the apparatus 20. After exiting the metering valve 430, other additives may be added to the gel concentrate at apertures 550. Various additives may be introduced to change the chemical or physical properties of the gel concentrate as required, for example, by the geology of the well formation and reservoir. The gel concentrate is then conveyed through one of pipes 530 or 540 and into the hydration tank 260. The gel concentrate may be made to flow along either of pipes 530 or 540 as required or desired.

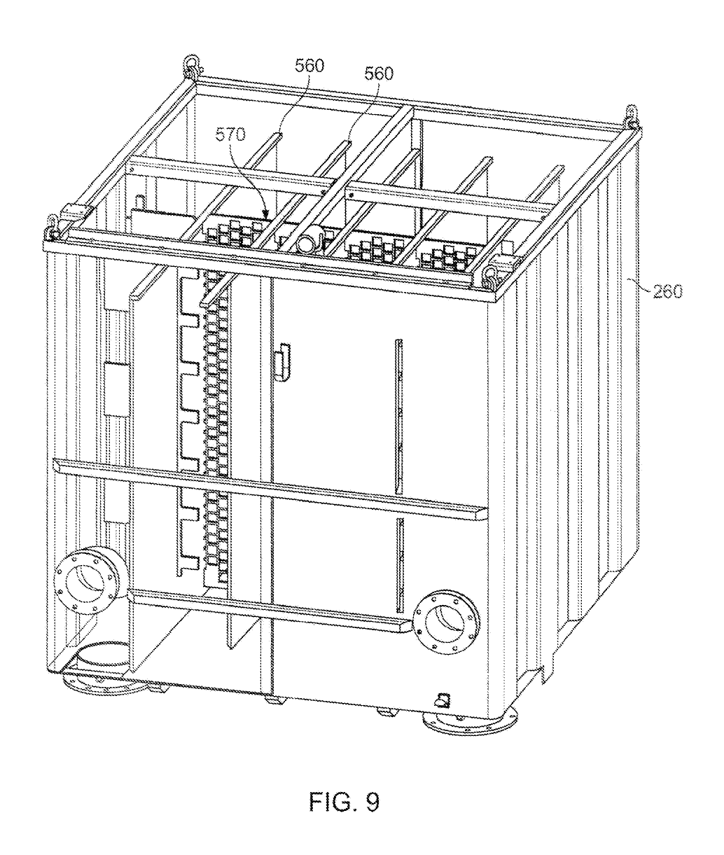

Once the gel concentrate has entered the hydration tank 260, the gel concentrate passes through a serpentine path formed by a series of weirs 560 contained within the hydration tank 260. According to one implementation, the interior of the hydration tank 260 includes a plurality of weirs 560 in a spaced, parallel relationship to establish a flow between one of the pipes 530, 540 and one of the outlets 580, 590. As a result of the shape and placement of the weirs 560, the flow of the gel concentrate through the hydration tank 260 forms a zig-zag shape both in vertical plane and in a horizontal plane. Accordingly, the weirs provide for an extended transient period during which the gel concentrate travels through the hydration tank 260. The hydration tank 260 may also include one or more flow divider screens 570 (shown in FIG. 9). The hydration tank 260 allows the gel concentration (and completed gel, where applicable) to hydrate as the gel concentrate passes therethrough. According to one implementation, the hydration tank 260 is of a type described in U.S. Pat. No. 6,817,376, the entirety of which is incorporated herein by reference.

After passing through the hydration tank 260, the gel concentrate is released from the tank from an outlet. Two outlets are provided in the implementation shown in FIGS. 5 and 7-9, although other implementations may include more or fewer outlets. The outlet used to release the gel concentrate may depend upon the location where the gel entered the hydration tank 260. For example, if the gel concentrate entered the hydration tank through the pipe 530, the gel concentrate may be released from outlet 580 when valve 300 is opened. The gel concentrate may then be released from the mixing system 250 via the fittings 470. Alternately, if the gel concentrate entered the hydration tank 260 via the pipe 540, the gel concentrate may leave the hydration tank 260 through the outlet 590. The gel concentrate may then be released from the mixing system 250 through fittings 600 when valve 380 is closed and valves 440 and 590 are opened. Discharging the gel concentrate through the portion of the mixing system 250 including the fittings 600 is advantageous because the flowrate of the gel concentrate can be better controlled, as explained below. Accordingly, the hydration tank 260 is ambidextrous, providing added flexibility to the apparatus 20. This is especially useful on a worksite that may have space limitations and repositioning the apparatus 20 is not convenient or possible. Thus, the apparatus 20, such as the apparatus shown in FIG. 2, may be positioned only once on a work site without regard to orientation.

The ambidextrous quality of the apparatus 20 is further illustrated by the two transverse pipes 640 and 650 extending between the longitudinal pipes 660 and 670, as illustrated in FIG. 5. Thus, rather than inputting the liquid into the apparatus at the fixtures 460 and/or 470, the liquid may be input at fittings 630 (and 620, if desired, by opening valve 400 and closing valve 390). The liquid is then conveyed to the suction pump 280 by closing the valves 400 (if liquid is only being supplied to fittings 650) and 320. The liquid may be combined with the dry gel as described above and directed to the hydration tank 260 as also described above.

Further, the finished gel may be released directly after being produced by the gel mixer 290 through fittings 610 and/or 470 by opening one or more of valves 330 and 360 and closing valves 340 and 350. Further, if desired, the finished gel could also be released via the fittings 460 and 620 by opening valves 310 and 390, respectively, and closing valves 400 and 320. Thus, the finished gel may be transported to an another holding tank or other location for subsequent use or processing.

An additional advantage of the present disclosure is that the mixing system 250 is configurable into a First In/First Out (“FIFO”) configuration. Thus, as the gel concentrate is produced, the gel concentrate first to enter the hydration tank 260 is also the first gel concentrate to leave the hydration tank 260 after passing through the zig-zag path formed by the weirs 560 and divider screens 570. As a result, the most hydrated gel concentrate is withdrawn from the mixing system 250 first.

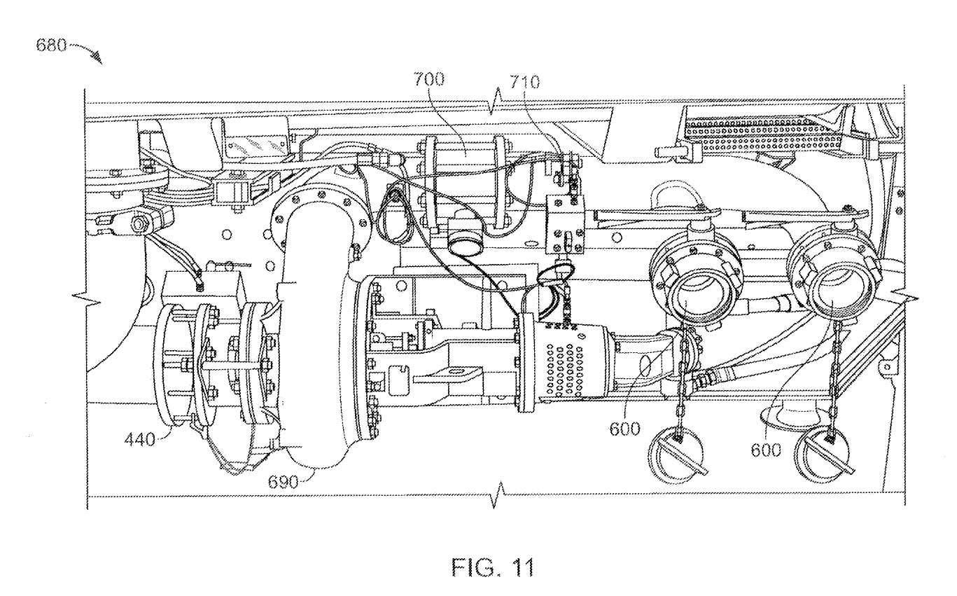

While the gel concentrate may be released from the apparatus 20 without any flow control, controlling the flow of gel concentrate out of the apparatus 20 may be desirable in some implementations. Accordingly, the mixing system 250 of the apparatus 20 may include a concentrate output system 680, shown in FIG. 11. The concentrate output system 680 may include the valve 440 and the fittings 600 as well as a pump 690, a flowmeter 700, and a metering valve 710. According to one implementation, the pump 690 is a Mission Magnum 8×6 centrifugal pump available from National Oilwell Varco, 10000 Richmond Ave., Houston, Tex. 77042, although the present disclosure is not so limited, and other pumps may be utilized. Additionally, the flowmeter 700 may be a number of possible different flow measuring devices, such as a Rosemount magnetic flowmeter available from Rosemount at 8200 Market Blvd., Chanhassen, Minn. 55317, and the metering valve 710 may be a number of possible different valves or mechanisms to throttle or meter the flow of the gel concentrate, such as a tub level valve. Similarly, flowmeter 700 and metering valve 710 are not limited to the examples provided but may be any device operable to measure and control the flowrate of the gel concentrate, respectively. The pump 690, flowmeter 700, and the metering valve 710 may provide for a constant, specified flowrate of the gel concentrate that can be dynamically changed on the fly, for example, depending on the changing needs of a well fracturing operation. The gel concentrate may be directed to the concentrate output system by opening valve 440 and closing valve 380, as shown in FIG. 5. The gel concentrate output system 680 provides for a controlled output of the gel concentrate in which a control unit 730 (described in greater detail below) may monitor the flowrate of the gel concentrate with an output from the flowmeter 700. The control unit 730 may then increase or decrease the pumping rate of the pump 690 to maintain a specified flow of the gel concentrate.

After leaving the apparatus 20, the gel concentrate is transported to the blender apparatus 50 where the gel concentrate is combined with additional liquid and sand from the liquid source 30 and sand source 40, respectively. The blender apparatus 50 agitates and combines the ingredients to quickly produce a finished gel and sand mixture that is subsequently injected into the well 60. Thus, when the gel concentrate and liquid are blended in the blender apparatus, the combination dilutes quickly to form a finished gel.

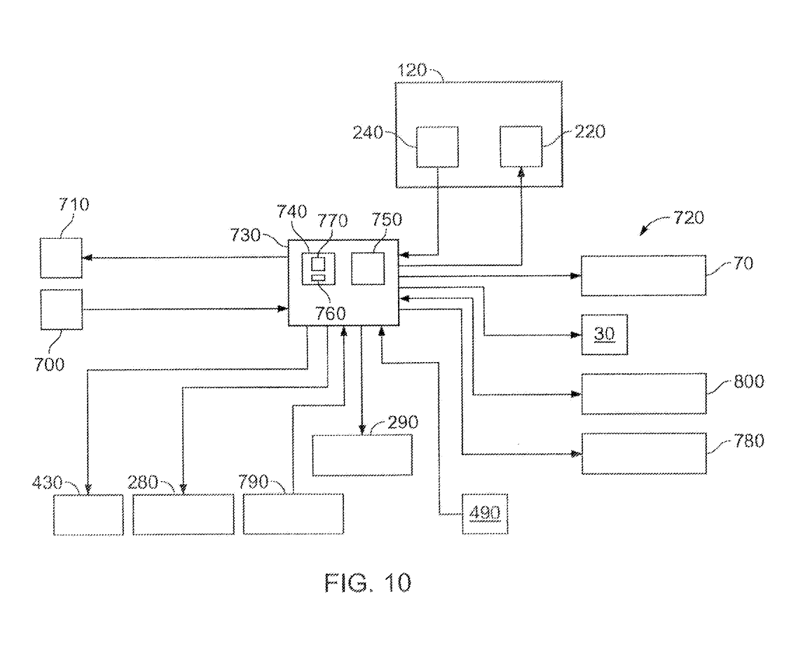

The system 10 may also include a control system 720, shown in FIG. 10, for accurately measuring and controlling the rate and properties of the gel being injected into the well 60. The control system 720 may include control unit 730 having a processor 740, memory 750, application 760, and information 770.

The control unit 730 may be implemented in digital electronic circuitry, or in computer software, firmware, or hardware, including the structural means disclosed in this specification and structural equivalents thereof, or in combinations of them. The control unit 730 can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

Processor 740 executes instructions and manipulates data to perform the operations and may be, for example, a central processing unit (CPU), a blade, an application specific integrated circuit (ASIC), or a field-programmable gate array (FPGA). Although FIG. 10 illustrates a single processor 740, multiple processors may be used according to particular needs and reference to processor 740 is meant to include multiple processors where applicable. Processors suitable for the execution of a computer program include, by way of example, both general and special purpose microprocessors, and any one or more processors of any kind of digital computer. Generally, the processor will receive instructions and data from ROM or RAM or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In the illustrated embodiment, processor 740 executes application 760.

Memory 750 may include any memory or database module and may take the form of volatile or non-volatile memory including, without limitation, magnetic media, optical media, random access memory (RAM), read-only memory (ROM), removable media, or any other suitable local or remote memory component. Illustrated memory 750 may include application data for one or more applications, as well as data involving VPN applications or services, firewall policies, a security or access log, print or other reporting files, HTML files or templates, related or unrelated software applications or sub-systems, and others. Consequently, memory 750 may also be considered a repository of data, such as a local data repository for one or more applications.

The control system 720 may also include an output device 780, such as a display device, e.g., a cathode ray tube (“CRT”) or LCD (liquid crystal display) monitor, for displaying information to the user as well as an input device 790, such as a keyboard and a pointing device, e.g., a mouse or a trackball, by which the user can provide input to the computer. Other kinds of devices can be used to provide for interaction with a user as well to provide the user with feedback. For example, feedback provided to the user can be any form of sensory feedback, e.g., visual feedback, auditory feedback, or tactile feedback; and input from the user can be received in any form, including acoustic, speech, or tactile input.

The application 760 is any application, program, module, process, or other software that may utilize, change, delete, generate, or is otherwise associated with the data and/or information 770 associated with one or more control operations of the system 10. “Software” may include software, firmware, wired or programmed hardware, or any combination thereof as appropriate. Indeed, application 760 may be written or described in any appropriate computer language including C, C++, Java, Visual Basic, assembler, Perl, any suitable version of 4GL, as well as others. It will be understood that, while application 760 may include numerous sub-modules, application 760 may instead be a single multi-tasked module that implements the various features and functionality through various objects, methods, or other processes. Further, while illustrated as internal to control unit 730, one or more processes associated with application 760 may be stored, referenced, or executed remotely (e.g., via a wired or wireless connection). For example, a portion of application 760 may be a web service that is remotely called, while another portion of application 760 may be an interface object bundled for processing at remote client 800. Moreover, application 760 may be a child or sub-module of another software module or application (not illustrated). Indeed, application 760 may be a hosted solution that allows multiple parties in different portions of the process to perform the respective processing.

The control system 720 receives information from numerous sources and control various operations of the system 10. According to one implementation, the control unit 730 monitors and controls the dry gel handling system 120 by receiving data from the load cells 240 and the second horizontal conveyor 220. Because the rate at which the second horizontal conveyor 220 is able to deliver the dry gel to the gel mixer 290 when the hopper 210 if maintained in a full condition is known, the control unit 730 can confirm that the dry system 120 is operating properly by monitoring the change in the output from the load cells 240. If the output from the load cells 240 are not changing over time or if the changes are less than expected (based on the known output rate at which the second horizontal conveyor 220 when operational), the control unit 720 may issue a warning, such as by illuminating a light or placing a message on a screen, or stop the operation of a portion or all of the apparatus 20 or any other portion of the system 10.

The control unit 730 may also control and monitor an amount of liquid delivered to the gel mixer 290, for example, to produce a gel concentrate of a defined mix ratio. According to one implementation, the control unit 730 receives flowrate information of the liquid from the flowmeter 490. The control unit 730 may then control the flow of the liquid at a specified set point by adjusting the pump speed of the suction pump 280. For example, if the flowrate of the liquid delivered to the gel mixer 290 is below the set point, the control unit 730 may increase pump speed to increase the flowrate of liquid. Conversely, if the flowrate of liquid delivered to the gel mixer 290 is too high, the control unit 730 may reduce the pump speed of the suction pump 280 to reduce the flowrate of the liquid. Accordingly, by controlling the weight of dry gel and liquid delivered to the gel mixer 290, the control unit 730 is capable of monitoring and controlling the mixing ratio and, hence, weight of the gel concentrate exiting the gel mixer 290.

The control unit 730 may also control the flow of the gel concentrate exiting the gel mixer 290 by adjusting the metering valve 430. Adjusting the output of gel concentrate from the gel mixer 290 via the metering valve 430 may be utilized to control a level of the gel concentrate in the hydration tank 260. Thus, the flow of gel concentrate to the hydration tank 260 may be increased or decreased depending on the outflow rate of gel concentrate from the hydration tank to maintain a desired or specified level of gel within the hydration tank. Concurrent with adjusting the outflow rate of gel concentrate from the gel mixer 290 with the metering valve 430, the control unit 730 may also adjust the suction pump 280 speed and the second horizontal conveyor 220 feed rate to control an amount of liquid and dry gel, respectively, being supplied to the gel mixer 290.

The control unit 730 may also be utilized to control the final mix ratio of the finished gel. Referring again to FIG. 1, the liquid source 30 provides a liquid to both the apparatus 20 as well as the blender apparatus 50. The apparatus 20 provides the gel concentrate to the blender apparatus 50. According to one implementation, the liquid source 30 provides a constant or substantially constant flow of liquid to the blender apparatus 50. Therefore, to maintain a specified mixture ratio of liquid to gel concentrate so that a gel having desired properties (such as a required viscosity) is produced, the control unit 730 adjusts the metering valve 710 of the concentrate output system 680 (shown in FIG. 11) to control the amount of gel concentrate provided to the blender apparatus 50. Referring to FIG. 10, the control unit 730 receives a flowrate measurement of the gel concentrate from the flowmeter 700 and controls the output of the gel concentrate, e.g., increases or decreases the gel concentrate flowrate from the hydration tank 260, by adjusting the metering valve 710. Additionally, sand from the sand source 40 may be added to the blender apparatus 50 where the liquid, gel concentrate, and sand are mixed to form the gel, which is subsequently injected into the well 60, for example, to perform a fracturing operation on the well 60.

According to other implementations, the control unit 730 may control the formation of gel utilizing the gel concentrate without monitoring the gel concentrate level in the hydration tank 260. This may be accomplished by monitoring the flowrate of gel concentrate exiting the concentrate output system 680 via the flowmeter 700 while also monitoring the flow of gel concentrate out of the gel mixer 290. Because gel concentrate into the hydration tank 260 must equal the gel concentrate out of the hydration tank 260 to maintain continuity, i.e., maintain the gel concentrate within the hydration tank at a specified level, the control unit 730 may ensure that the hydration tank 260 maintains a minimum or specified level without having to directly monitor the hydration tank 260. To maintain continuity, the control unit 730 may control the outlet of the gel concentrate with the metering valve 710 (shown in FIGS. 5 and 11) and the inlet of gel concentrate with pump speed of the suction pump 280 and the metering valve 430.

According to other implementations, the control system 720 may monitor and/or control more or fewer operations of the system 10, such as the amount of additives 70 introduced into the dry gel at the nozzles 550 or an amount of liquid from the liquid source 30 delivered to the blender apparatus 50.

According to further implementations, the control system 10 may be remotely monitored and manipulated with the control system 720 via wired or wireless connection at a remote location, such as remote client 800, shown in FIG. 10. Thus, a user located at a separate location may be able to monitor and control the system 10 over the Internet, for example.

The apparatus 20 may also be capable of producing gel directly, as shown in FIG. 12. The completed gel may be produced in a manner similar to the process described above, except that a greater volume of liquid, e.g., water, is combined with the dry gel when the two components are mixed together at the gel mixer 290. As illustrated, liquid is provided from the liquid source 20 only to the apparatus. That is, no liquid is provided to the blender apparatus 50 for the purpose of combining with the gel. Additives 70 may also be provided to the apparatus 20 for inclusion in the gel. After the gel is produced by the apparatus 20, the gel is conveyed to the blender apparatus 20 and combined with sand from sand source 40. Moreover, the direct gel production method has the added disadvantage that any required change in properties of the gel, such as viscosity, do not take effect immediately. Rather, the already produced gel contained in the hydration tank 260 acts as a buffer and mixes with the newly produced gel at a different viscosity until the already produced gel is consumed. According to one implementation, an external hydration tank has a working volume of 500 barrels (bbl). This volume equates to roughly one hour's worth of use in a fracturing operation, which, on the average, may run about four hours. Therefore, in order to affect a change in viscosity of the directly produced gel, operators must wait approximately one quarter of the total time of the well fracturing operation before any changes are seen down well. Accordingly, responsiveness to changes in gel formed by a direct gel production operation is very low.

On the contrary, gel produced using a gel concentrate, requires significantly less total time. For example, in one implementation, forming the gel from the gel concentrate in the blender apparatus 50 prior to injection into the well produces the resulting gel almost instantaneously. Thus, any changes in gel properties, such a change in the gel viscosity, may be made on the fly by changing a ratio of the gel concentrate and liquid combined in the blender apparatus 50. Thus, fracturing operations using a gel made from gel concentrate may be performed more efficiently since changes in properties (e.g., viscosity) may be changed substantially instantaneously with injection of the gel into the well, eliminating the time lag between using up a batch of gel having one set of properties and the start of the use of a new batch of gel having a different, desired set of properties.

Additionally, the gel produced using a gel concentrate does not require the addition of any hydrocarbon carriers, such as liquid gel concentrate (LGC), surfactants, or thickening agents. Thus, the gel may be produced with only a dry gel polymer and a liquid, such as water. Accordingly, the gel produced by the system and method of the present disclosure is less expensive due to the elimination of any other required materials and provides for a smaller environmental impact.

A number of implementations of the invention have been described. Nevertheless, it will be understood that various modifications may be made without departing from the spirit and scope of the invention. Accordingly, other implementations are within the scope of the following claims.

What is claimed is:

1. A method for producing a polymer gel for use in hydraulic well fracturing comprising:
combining a specified amount of a gel particulate with a specified amount of a base fluid at a surface well site to form a polymer gel concentrate; and
combining the polymer gel concentrate with an additional fluid to form a gel.

2. The method according to claim 1, further comprising blending the specified amount of the gel particulate and the base fluid to form a polymer gel concentrate with a polymer gel concentrate mixing apparatus having an impeller.

3. The method according to claim 2, wherein the polymer gel concentrate mixing apparatus comprises:
a mixer having a housing defining an inner chamber;
a base fluid inlet connected to the housing and capable of directing the base fluid into the inner chamber of the housing;
a gel particulate inlet connected to the housing and capable of directing the gel particulate into the inner chamber;
an outlet connected to the housing and capable of directing a substantially hydrated polymer gel away from the housing, wherein the base fluid inlet is at least partially inside of the outlet; and
an impeller within the housing, the impeller having a plurality of impeller blades extending radially outwardly from a hub, the impeller blades for rotating about the hub thereby creating a centrifugal flow.

4. The method according to claim 1, wherein combining the polymer gel concentrate with an additional fluid to form a gel comprises blending a specified amount of polymer gel concentrate with a specified amount of the liquid to form a completed polymer gel.

5. The method according to claim 4, wherein combining the specified amount of polymer gel concentrate with the specified amount of the liquid further comprises combining a specified amount of sand with the specified amount of polymer gel concentrate and the specified amount of liquid, and
wherein blending the specified amount of polymer gel concentrate with the specified amount of the liquid to form the completed polymer gel further comprises blending the specified amount of sand with the specified amount of polymer gel concentrate and the specified amount of the liquid.

6. A method for producing a gel for use in hydraulic well fracturing comprising:
introducing a specified amount of a first liquid into a polymer gel concentrate mixer at a surface well site;
introducing a specified amount of dry polymer gel into the polymer gel concentrate mixer;
blending the specified amounts of the first liquid and the dry polymer gel in a polymer gel concentrate mixing apparatus to form a polymer gel concentrate;
hydrating the polymer gel concentrate for a specified period of time;
outputting a specified amount of the polymer gel concentrate to a polymer gel blender apparatus; and
combining the specified amount of the polymer gel concentrate with a specified amount of a second liquid in the polymer gel blender apparatus to form a polymer gel.

7. The method according to claim 6, wherein the polymer gel concentrate mixer includes an impeller having a plurality of impeller blades extending radially outwardly from a hub, the impeller blades for rotating about the hub thereby creating a centrifugal flow.

8. The method according to claim 6, wherein the first liquid is water.

9. The method according to claim 6, wherein the second liquid is water.

10. The method according to claim 6, wherein dry polymer gel is selected from the group consisting of cmhpg, hpg, guar, hec, and cmhec.

11. The method according to claim 6, wherein hydrating is performed in a hydrating tank containing a plurality of weirs.

12. The method according to claim 6, wherein outputting the specified amount of the polymer gel concentrate to the polymer gel blender apparatus comprises:
measuring a flow of the polymer gel concentrate with a flow measuring device; and
adjusting an opening amount of a valve operable to meter the flow of the polymer gel concentrate based on the measured flow from the flow measuring device.

13. The method according to claim 6 further comprising introducing the polymer gel into a well.

14. The method according to claim 13 further comprising performing a well fracturing operation utilizing the polymer gel introduced into the well.

15. A control method for producing a polymer gel comprising:
forming a polymer gel concentrate;
supplying an amount of a liquid and an amount of the polymer gel concentrate to a blending apparatus;
determining the amount of the liquid supplied to the blending apparatus;
adjusting the amount of polymer gel concentrate supplied to the blending apparatus based on the amount of the liquid supplied to the blending apparatus to maintain a specified mixture ratio of the liquid and the polymer gel concentrate to produce a polymer gel having a specified composition.

16. The method according to claim 15, wherein determining the amount of the liquid supplied to the blending apparatus comprises receiving a liquid flowrate measurement from a first flow measurement device, and
wherein adjusting the amount of polymer gel concentrate supplied to the blending apparatus based on the amount of the liquid supplied to the blending apparatus to maintain a specified mixture ratio of the liquid and the polymer gel concentrate to produce a polymer gel having a specified composition comprises:
receiving a polymer gel concentrate flowrate measurement from a second flow measurement device; and
adjusting the flowrate of the polymer gel concentrate to maintain the specified mixture ratio of the liquid and the polymer gel concentrate.

17. The method according to claim 16, wherein the first and second flow measurement devices are flowmeters.

18. The method according to claim 16, wherein adjusting the flowrate of the polymer gel concentrate to maintain the specified mixture ratio between the liquid and the polymer gel concentrate comprises adjusting an opening amount of a valve operable to meter the flowrate of the polymer gel concentrate.

19. The method according to claim 15 wherein forming a polymer gel concentrate comprises:
supplying an amount of a liquid and a dry polymer gel to a polymer gel concentrate mixing apparatus;
measuring at least one of the amount of the liquid or the dry polymer gel supplied to the polymer gel concentrate mixing apparatus; and
adjusting the other of the amount of the liquid or the dry polymer gel supplied to the polymer gel concentrate mixing apparatus to produce the polymer gel concentrate having a specified composition.

20. The according to claim 19 wherein measuring at least one of the amount of the liquid or the dry polymer gel supplied to the polymer gel concentrate mixing apparatus comprises measuring a flowrate of the dry gel polymer supplied to the polymer gel concentrate mixing apparatus, and
wherein adjusting the other of the amount of the liquid or the dry polymer gel supplied to the polymer gel concentrate mixing apparatus to produce the polymer gel concentrate having the specified composition comprises:
measuring a flowrate of the liquid supplied to the polymer gel concentrate mixing apparatus; and
adjusting the flowrate of the liquid to maintain the specified ratio of the liquid and the dry polymer gel.

21. The method according to claim 19, wherein measuring at least one of the amount of the liquid or the dry polymer gel supplied to the polymer gel concentrate mixing apparatus comprises measuring a flowrate of the liquid supplied to the polymer gel concentrate mixing apparatus, and
wherein adjusting the other of the amount of the liquid or the dry polymer gel supplied to the polymer gel concentrate mixing apparatus to produce the polymer gel concentrate having a specified composition comprises:
measuring a flowrate of the dry gel polymer supplied to the polymer gel concentrate mixing apparatus; and
adjusting the flowrate of the dry gel polymer to maintain the specified ratio of the liquid and the dry polymer gel.
